(19) United States
(12) Patent Application Publication
(10) Pub. No.: US 2013/0077109 A1
(43) Pub. Date: Mar. 28, 2013

(54) PRINTING SYSTEM, PRINTING SYSTEM CONTROL METHOD, AND STORAGE MEDIUM

(71) Applicant: Toru Wakana, Yokohama-shi (JP)

(72) Inventor: Toru Wakana, Yokohama-shi (JP)

(73) Assignee: CANON KABUSHIKI KAISHA, Tokyo (JP)

(21) Appl. No.: 13/597,052

(22) Filed: Aug. 28, 2012

(30) Foreign Application Priority Data
Sep. 1, 2011 (JP) 2011-190495

(51) Int. Cl. G06K 15/16

(52) U.S. Cl. CPC G06K 15/16
USPC 358/1.12

(57) ABSTRACT

To provide a printing system for selecting a sheet storage unit to be used in printing by ignoring a grouping setting set to the sheet storage unit in a case where a print job in which a sheet size is designated is received.

### BACKGROUND OF THE INVENTION

1. Field of the Invention

The present invention relates to a printing system, a control method for controlling the printing system, and a storage medium thereof.

2. Description of the Related Art

Japanese Patent Laid-open Publication No. 2009-256077 discusses a printing system in which an information processing apparatus can communicate with a printing apparatus, wherein the printing apparatus including a plurality of sheet cassettes has such a function that the plurality of sheet cassettes are grouped according to a type of sheet accommodated therein and thus grouped sheet cassettes are virtually considered as a single sheet cassette. Hereinafter, the above described function is referred to as the sheet cassette grouping.

In this case, when an operator designates paper feeding from a sheet cassette belonging to the group via, for example, a printer driver, even if the sheet cassette runs out of sheets, the other sheet cassette belonging to the same group can feed sheets. In other words, a sheet cassette is automatically selected only from among the sheet cassettes belonging to the same group.

However, in the recent years, there has been such a demand that the sheet cassettes are automatically switched, when the sheet cassette runs out of sheets, even in a case of executing a job in which a specific sheet cassette is designated. For example, as discussed in the above described Japanese Patent Laid-open Publication No. 2009-256077, a user instruction enables grouping of some sheet cassettes and switching of the sheet cassettes among the sheet cassettes belonging to the group. According to the technique, even in a case where the user designates a specific sheet cassette, printing can be continued by using sheets of the other sheet cassette when the specific sheet cassette runs out of sheets.

The conventional printing system as discussed in the above described Japanese Patent Laid-open Publication No. 2009-256077, however, always uses only the sheet cassettes belonging to the same group once printing is started with the sheet cassette having been grouped. Therefore, sheets of a sheet cassette other than the grouped sheet cassettes cannot be used.

For example, in the printing system, in a case where a sheet cassette not belonging to the same group includes sheets having a size used in printing, the sheets accommodated in this sheet cassette cannot be automatically (i.e., without designating any specific sheet cassette) fed

### SUMMARY OF THE INVENTION

The present invention is directed to a printing system for conveying a sheet from any one of a plurality of sheet storage units and printing an image on the conveyed sheet, wherein the printing system includes a registering unit configured to register 2 or more sheet storage units as a group among the plurality of sheet storage units, and a control unit configured to continue printing by changing a sheet conveyance source based on the group registered by the registering unit in a case where an amount of sheets accommodated in a specific sheet storage unit becomes equal to or less than a predetermined amount during execution of a job in which the specific sheet storage unit is designated among the plurality of sheet storage units, and to continue printing by changing the sheet storage unit to the other sheet storage unit accommodating sheets having the designated size, regardless of the group registered in the registering unit, in a case where an amount of sheets of the sheet storage unit accommodating the sheets having the designated size becomes equal to or less than a predetermined amount during execution of the job in which a size of the sheet is designated.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a printing system.

FIG. 2 illustrates a configuration of a Multi Function Peripheral (MFP) of FIG. 1.

FIG. 3 is a block diagram illustrating a configuration of the printing system of FIG. 1.

FIG. 4 is an explanatory flow chart illustrating a control method for controlling a printing system according to the present exemplary embodiment.

FIG. 5 is a flow chart illustrating a control method for controlling the printing apparatus according to the present exemplary embodiment.

FIG. 6 illustrates an example of a sheet cassette setting screen displayed on a UI screen of FIG. 3.

FIG. 7 illustrates an example of another sheet cassette setting screen displayed on the UI screen of FIG. 3.

FIG. 8 illustrates an example of yet another sheet cassette setting screen displayed on the UI screen of FIG. 3.

FIG. 9 illustrates an example of still another sheet cassette setting screen displayed on the UI screen of FIG. 3.

FIG. 10 illustrates sheet cassette grouping setting information.

FIG. 11 illustrates another sheet cassette grouping setting information.

FIG. 12 is a flow chart illustrating a control method for controlling the printing apparatus.

FIG. 13 is a flow chart illustrating another control method for controlling the printing apparatus.

FIG. 14 is a flow chart illustrating yet another control method for controlling the printing apparatus.

FIG. 15 is a flow chart illustrating yet another control method for controlling the printing apparatus.

FIG. 16 is a flow chart illustrating yet another control method for controlling the printing apparatus.

FIG. 17 is a flow chart illustrating still another control method for controlling the printing apparatus.

### DESCRIPTION OF THE EMBODIMENTS

Various exemplary embodiments, features, and aspects of the invention will be described in detail below with reference to the drawings.

### <Explanation of a System Configuration>

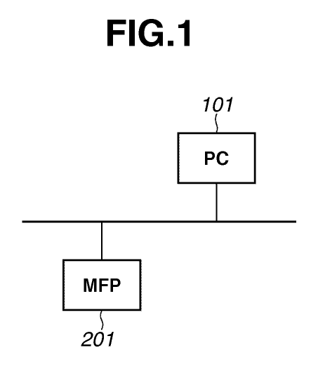

FIG. 1 is a block diagram illustrating a configuration of a printing system according to a first exemplary embodiment. The printing system includes an information processing apparatus and a printing apparatus. The present exemplary embodiment illustrates an example of a system in which an information processing apparatus (i.e., PC) and a Multi Function Peripheral (MFP) including a printing function can communicate with each other. However, the system may be configured such that a plurality of PCs and a plurality of MFPs are connected with each other. The system also may be configured such that the Multi Function Peripheral (MFP) is connected to a Single Function Peripheral (SFP).

In FIG. 1, an information processing apparatus 101 (i.e., PC) such as a host computer creates document data by using an arbitral application, and generates print data by using, for example, a printer driver. A Multi Function Peripheral (MFP) 201 includes at least a plurality of sheet feeding units as described below and the sheet feeding units can be divided into groups. The below described sheet storage unit includes paper feeding decks and paper decks. The decks are collectively referred to as sheet cassettes.

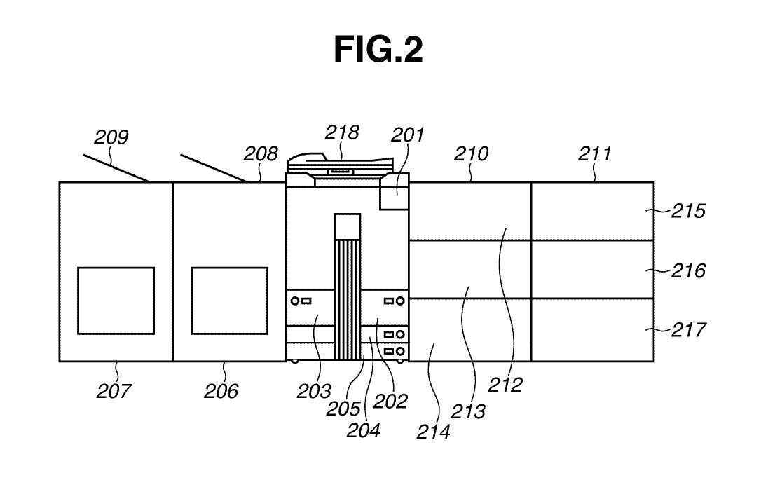

FIG. 2 illustrates a configuration of the MFP 201 of FIG. 1. In the present exemplary embodiment, a printing system in which sheet materials are fed from a plurality of sheet storage units (i.e., sheet cassettes) is illustrated as an example.

In FIG. 2, a main body of the MFP 201 can be connected with a sheet processing apparatus and a paper sheet feeding unit. A paper feeding deck 202 is mounted on a main body of the MFP 201 and can accommodate sheets to be printed by the MFP 201. A paper feeding deck 203 is mounted on the main body of the MFP 201 and can accommodate sheets to be printed by the MFP 201.

A paper feeding deck 204 is mounted on the main body of the MFP 201 and can accommodate sheets to be printed by the MFP 201. A paper feeding deck 205 is mounted on the main body of the MFP 201 and can accommodate sheets to be printed by the MFP 201.

A sheet discharge stacker 206 is mounted on the main body of the MFP 201 and can discharge sheets after printed by the MFP 201 into a stacker in large numbers. A sheet discharge stacker 207 is mounted on the main body of the MFP 201 and can discharge sheets after printed by the MFP 201 into the stacker in large numbers.

A sample tray 208 is provided on the sheet discharge stacker 206 and can discharge a sheet after printed by the MFP 201. A sample tray 209 is provided on the sheet discharge stacker 207 and can discharge a sheet after printed by the MFP 201.

A paper deck 210 is connected to the main body of the MFP 201 and can accommodate sheets to be printed by the MFP 201. A paper deck 211 is connected to the main body of the MFP 201 and can accommodate sheets to be printed by the MFP 201. A paper feeding deck 212 is mounted on the paper deck 210 and can accommodate sheets to be printed by the MFP 201. A paper feeding deck 213 is mounted on the paper deck 210 and can accommodate sheets to be printed by the MFP 201. A paper feeding deck 214 is mounted on the paper deck 210 and can accommodate sheets to be printed by the MFP 201.

A paper feeding deck 215 is mounted on the paper deck 211 and can accommodate sheets to be printed by the MFP 201. A paper feeding deck 216 is mounted on the paper deck 211 and can accommodate sheets to be printed by the MFP 201. A paper feeding deck 217 is mounted on the paper deck 211 and can accommodate sheets to be printed by the MFP 201. An automatic document feeder 218 concurrently serving as a reading apparatus can read a document.

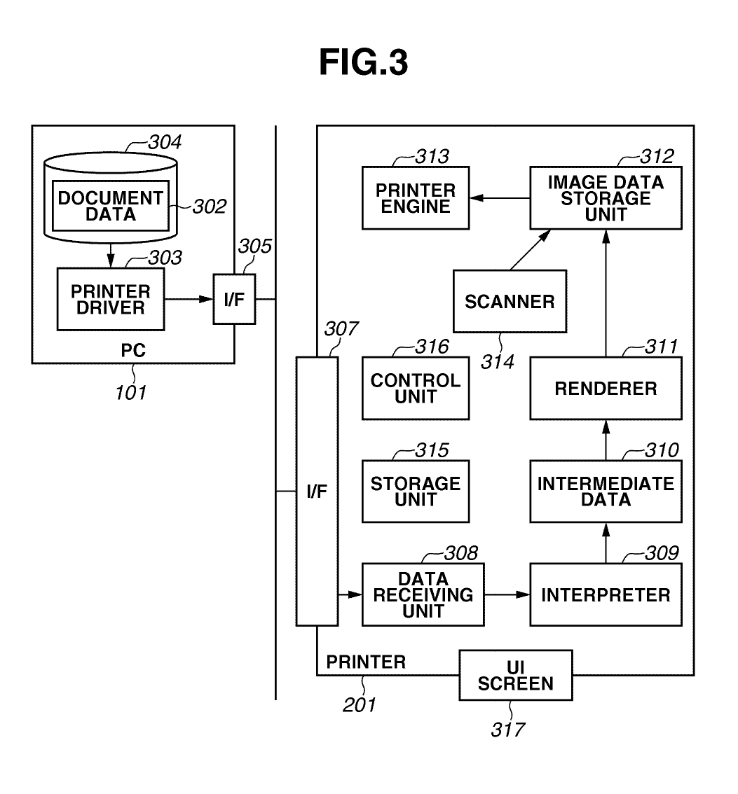

FIG. 3 is a block diagram illustrating a configuration of the printing system of FIG. 1.

In FIG. 3, document data 302 is stored in a host computer and is stored in, for example, a hard disk as an external storage device to be managed thereby. The document data described herein is data created by a document creation application.

A printer driver 303 creates Page Description Language (PDL) data based on the document data 302. The PDL described herein is a page description language such as a PS, a PCL, and a LIPS.

A storage area 304 is secured in the above described external storage device and stores the document data 302, the printer driver 303, an application for creating the document data 302, and the like. A communication interface (I/F) 305 transmits the PDL data created by the printer driver 303 to the MFP 201.

In the MFP 201, a communication interface (I/F) 307 receives the PDL data transmitted from the PC 101. A data receiving unit 308 receives PDL data via the communication I/F 307.

An interpreter 309 analyzes the PDL data received by the data receiving unit 308. The interpreter 309 can analyze a PDL format such as a PS format, a PCL format, and a LIPS format. It is needless to say that the PDL data may be formed into any format other than the above described formats. Intermediate data 310 is the PDL data (not illustrated) received by the data receiving unit 308, and analyzed and converted by the interpreter 309.

A renderer 311 analyzes the intermediate data 310 to convert it into image data. An image data storage unit 312 stores the image data resulting from processing by the renderer 311. A printer engine 313 converts the image data stored in the image data storage unit 312 into a video signal to print it.

A scanner 314 reads out a document. The image read out by the scanner 314 is stored in the image data storage unit 312 in the form of image data. A storage unit 315 is used to cache the intermediate data 310 and the image data. A control unit (CPU) 316 includes a ROM storing a program for executing various processing and a RAM as a work area according to the present exemplary embodiment. A user interface (UI) screen unit 317 is used in order to operate the MFP 201.

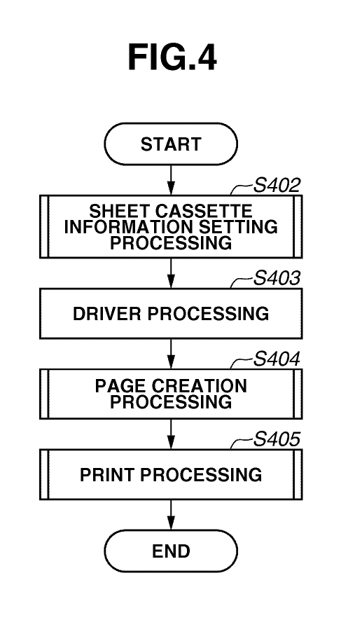

FIG. 4 is a flow chart illustrating a control method for controlling a printing system according to the present exemplary embodiment. FIG. 4 illustrates an example of print processing performed by an information processing apparatus and a printing apparatus of the printing system of FIG. 1.

Each step is realized such that a CPU of each of the PC 101 and the MFP 201 loads a control program read out from the ROM into the RAM to run the control program on the RAM. Now, an entire flow of the present printing system is described below. In the present exemplary embodiment, as illustrated in FIG. 2, a case where the printing apparatus is an MFP 201 having 10 sheet cassettes is described as an example for the sake of explanation. A case where the CPU of the control unit 316 executes modules is described below.

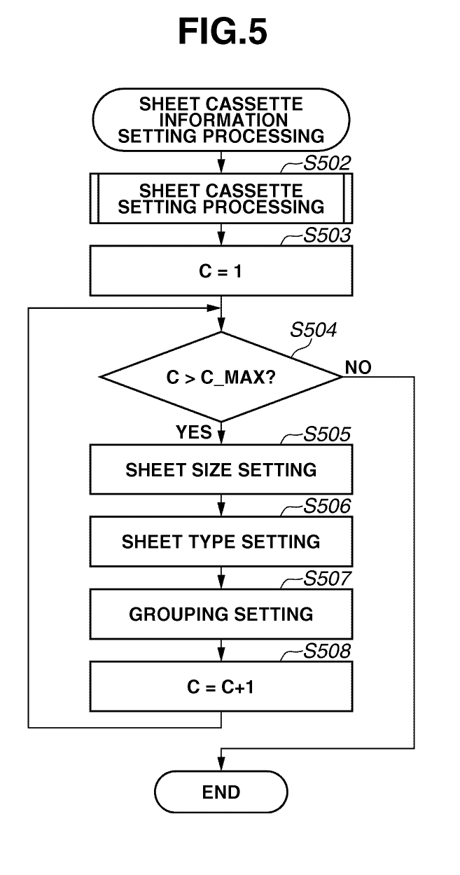

In step S402, in the MFP 201, the control unit 316 controls the UI screen 317 to perform sheet cassette information setting of the MFP 201. As a result, settings of a sheet size, a sheet type, and a group can be made with respect to the 10 sheet cassettes of the MFP 201. The sheet cassette information setting is described in detail with reference to a flow chart of FIG. 5.

In step S403, the PC 101 performs driver processing in which the printer driver 303 creates PDL data analyzable by the MFP 201. According to the processing, the PDL data is created based on the document data 302. A sheet cassette which feeds sheets is designated from among the sheet cassettes of the MFP 201. Hereinafter, it is referred to as sheet cassette designation.

In the sheet cassette designation, only one of “sheet cassette 1, Auto” through “sheet cassette 10, Auto” can be designated in the printer driver 303. The sheet cassette designation can be made by a command of, for example, the PDL.

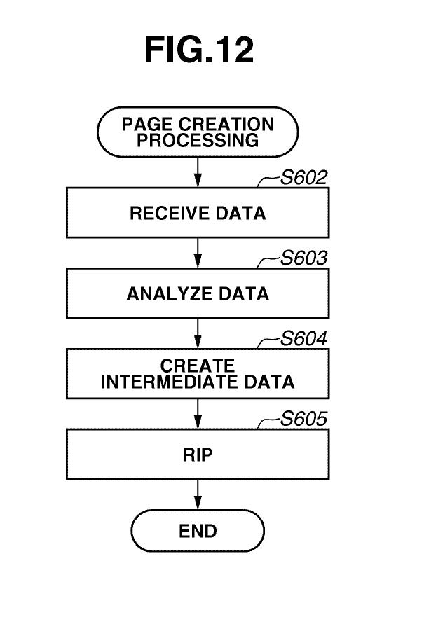

In step S404, page creation processing is performed by the MFP 201. According to the processing, the PDL data created by the interpreter 309 in step S403 is analyzed to create intermediate data 310 and the renderer 311 creates image data printable by the printer engine 313. The page creation processing is described below in detail with reference to a flow chart of FIG. 12.

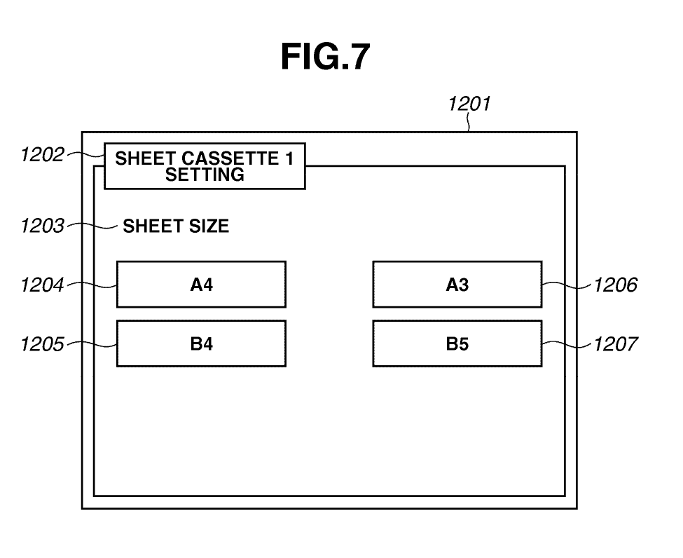

In step S405, the printer engine 313 performs print processing. According to the processing, the image data created in step S404 is printed on a sheet fed according to the sheet cassette designation set in step S403. The print processing is described below in detail with reference to a flow chart of FIG. 7.

FIG. 5 is a flow chart illustrating a control method for controlling the printing apparatus according to the present exemplary embodiment. FIG. 5 illustrates an example of the sheet cassette information setting processing. Each step is realized such that the CPU of the control unit 316 loads a control program read out from the ROM into the RAM to run the control program on the RAM.

In the present exemplary embodiment, the user makes settings of the sheet size, the sheet type, and the group of each sheet cassette via the UI screen 317.

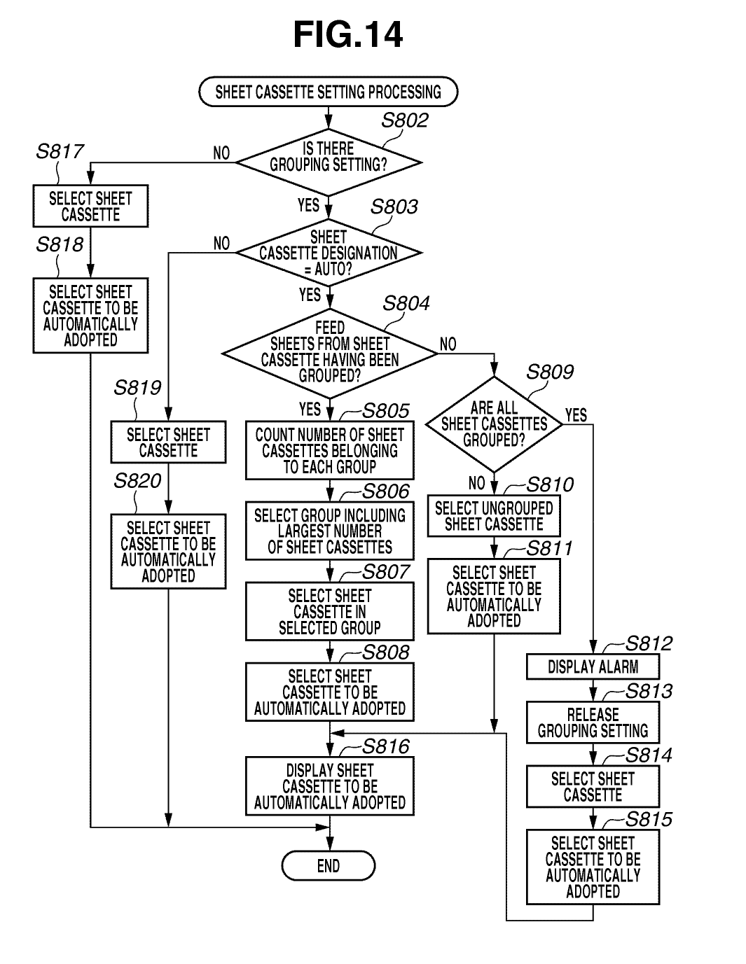

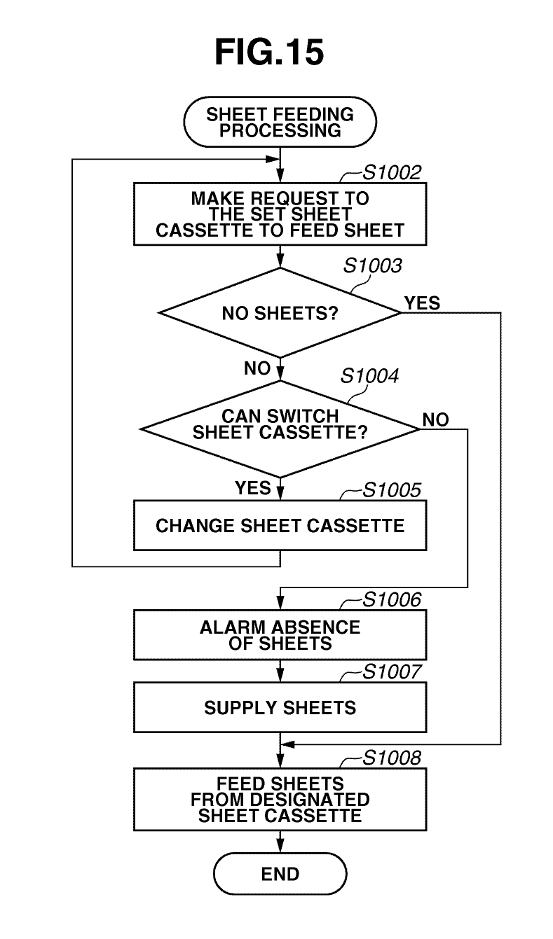

In step S502, the CPU performs sheet cassette setting processing according to the sheet cassette setting input by the user via the UI screen 317. In the sheet cassette setting processing, settings are made with respect to the sheet cassette which feeds sheets in response to the job or the sheet cassette capable of feeding sheets in response to the job. The sheet cassette setting processing is described below in detail with reference to FIG. 14 or FIG. 15.

In step S503, the CPU of the control unit 316 initializes a variable C for counting the number of sheet cassettes to “1”. Here, the variable C is an integer satisfying C≧1.

In the present exemplary embodiment, C=1 indicates the sheet cassette 202. C=2 indicates the sheet cassette 203. C=3 indicates the sheet cassette 204. C=4 indicates the sheet cassette 205. C=5 indicates the sheet cassette 212.

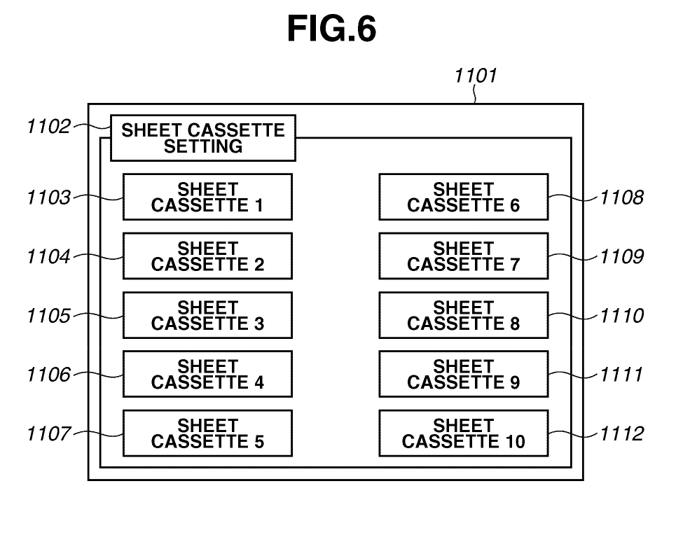

Similarly, C=6 indicates the sheet cassette 213. C=7 indicates the sheet cassette 214. C=8 indicates the sheet cassette 215. C=9 indicates the sheet cassette 216. Further, C=10 indicates the sheet cassette 217. The UI screen 317 displays a sheet cassette setting screen 1101 of FIG. 6. In a case of the present exemplary embodiment, since the MFP 201 includes 10 sheet cassettes, sheet cassettes 1103 through 1112 are shown.

FIGS. 6 through 9 illustrate examples of the sheet cassette setting screens displayed on the UI screen of FIG. 3.

FIG. 6 illustrates an entire sheet cassette setting screen 1101. A title menu 1102 indicates items which the UI screen 317 displays. The title menu is “sheet cassette setting”. A selection button 1103 makes a setting of the sheet cassette 202. When the user presses the selection button 1103, the user can make a setting of the sheet cassette 1.

A selection button 1104 makes a setting of the sheet cassette 203. When the user presses the selection button 1104, the user can make a setting of the sheet cassette 2. A selection button 1105 makes a setting of the sheet cassette 204. When the user presses the selection button 1105, the user can make a setting of the sheet cassette 3.

A selection button 1106 makes a setting of the sheet cassette 205. When the user presses the selection button 1106, the user can make a setting of the sheet cassette 4. A selection button 1107 makes a setting of the sheet cassette 212. When the user presses the selection button 1107, the user can make a setting of the sheet cassette 5. A selection button 1108 makes a setting of the sheet cassette 213. When the user presses the selection button 1108, the user can make a setting of the sheet cassette 6.

A selection button 1109 makes a setting of the sheet cassette 214. When the user presses the selection button 1109, the user can make a setting of the sheet cassette 7. A selection button 1110 makes a setting of the sheet cassette 215. When the user presses the selection button 1110, the user can make a setting of the sheet cassette 8.

A selection button 1111 makes a setting of the sheet cassette 216. When the user presses the selection button 1111, the user can make a setting of the sheet cassette 9. A selection button 1112 makes a setting of the sheet cassette 217. When the user presses the selection button 1112, the user can make a setting of the sheet cassette 10.

In step S504, the CPU of the control unit 316 determines whether the number of the sheet cassettes C is larger than the maximum value C_MAX of the number of the sheet cassettes. In a case where the CPU determines that C>C_MAX is satisfied (YES in step S504), there remains a sheet cassette required to be set, therefore, the processing proceeds to step S505. The C_MAX is an integer satisfying C_MAX≧1 and 10 sheet cassettes are included in the present exemplary embodiment, accordingly, C_MAX=10.

In step S505, the CPU of the control unit 316 makes a setting of the size of sheets to be accommodated in the sheet cassette according to an operation of the user via the UI screen 317. A case where C=1, i.e., a case where the setting is made with respect to the sheet cassette 1, is described here. When the sheet cassette 1103 is selected according to the operation of the user in the sheet cassette setting screen 1101 displayed on the UI screen 317, the control unit 316 shifts the screen displayed on the UI screen 317 to the sheet size setting screen as illustrated in FIG. 7.

FIG. 7 illustrates an entire screen of “sheet cassette 1 setting” 1201. A menu tab 1202 indicates an item displayed on the UI screen 317. The menu tab shows “sheet cassette 1 setting”. A title menu 1203 indicates that the sheet cassette 1 setting screen 1202 is a screen for setting the sheet size. The title menu shows “sheet size”.

A selection button 1204 makes a setting of sheet size to “A4”. A selection button 1205 makes a setting of sheet size to “B4”. A selection button 1206 makes a setting of sheet size to “A3”. A selection button 1207 makes a setting of sheet size to “B5”. In the present exemplary embodiment, the sheet size “A4” 1204 is set to all the sheet cassettes.

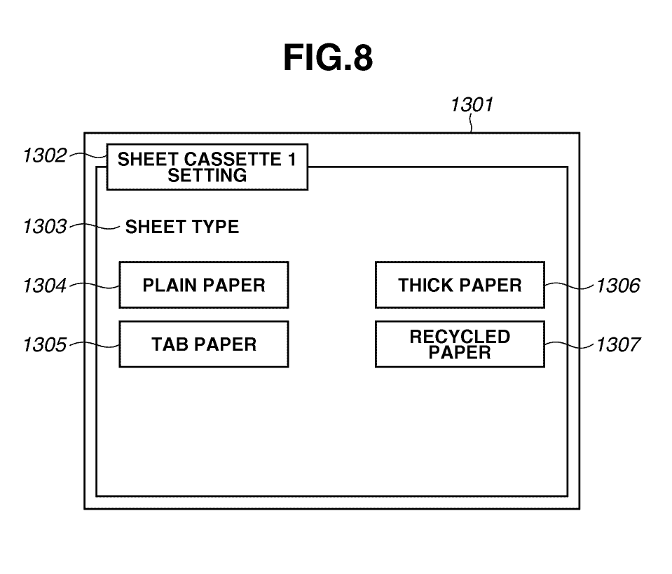

In step S506, the CPU of the control unit 316 makes a setting of the sheet type of sheets to be accommodated in the sheet cassette according to the operation of the user via the UI screen 317. When the user selects the selection button 1204 for setting the sheet size to A4 size in the sheet size setting screen 1201 displayed on the UI screen 317, the CPU of the control unit 316 shifts the screen displayed on the UI screen 317 to a sheet type-setting screen illustrated in FIG. 8.

FIG. 8 illustrates an entire sheet type-setting screen 1301. A menu tab 1302 indicates an item displayed on the UI screen 317. The menu tab shows “sheet cassette 1 setting”. A title menu 1303 indicates that the sheet cassette 1 setting screen 302 is a screen for setting the sheet type. The title menu shows “sheet type”.

A selection button 1304 sets the sheet type to a “plain paper”. A selection button 1305 sets the sheet type to a “tab paper”. A selection button 1306 sets the sheet type to a “thick paper”. A selection button 1307 sets the sheet type to a “recycled paper”.

In the present exemplary embodiment, the plain paper 1304 is set to all the sheet cassettes. In the present exemplary embodiment, only 4 different types of sheets can be selected. However, the number of selectable types of sheets may also be more than 4 or less than 4.

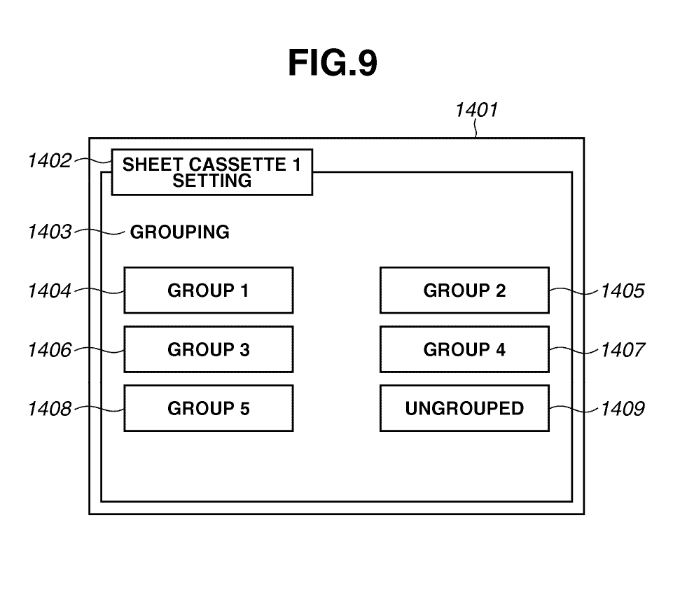

In step S507, the CPU of the control unit 316 receives a setting from the user via the UI screen 317 to perform group setting of the sheet cassettes. If the user selects the plain paper 1304 in the sheet type-setting screen 1301 displayed on the UI screen 317, the control unit 316 shifts the screen displayed on the UI screen 317 to a grouping setting screen illustrated in FIG. 9.

FIG. 9 illustrates an entire “grouping setting” screen 1401. A menu tab 1402 indicates an item displayed on the UI screen 317. The menu tab 1402 shows “sheet cassette 1 setting”. A title menu 1403 indicates that the sheet cassette 1 setting screen 1402 is a screen for setting grouping of the sheet cassettes. The title menu shows “grouping”.

A selection button 1404 sets the sheet cassette to group 1. A selection button 1405 sets the sheet cassette to group 2. A selection button 1406 sets the sheet cassette to group 3. A selection button 1407 sets the sheet cassette to group 4. A selection button 1408 sets the sheet cassette to group 5. A selection button 1409 sets the sheet cassette to ungrouped.

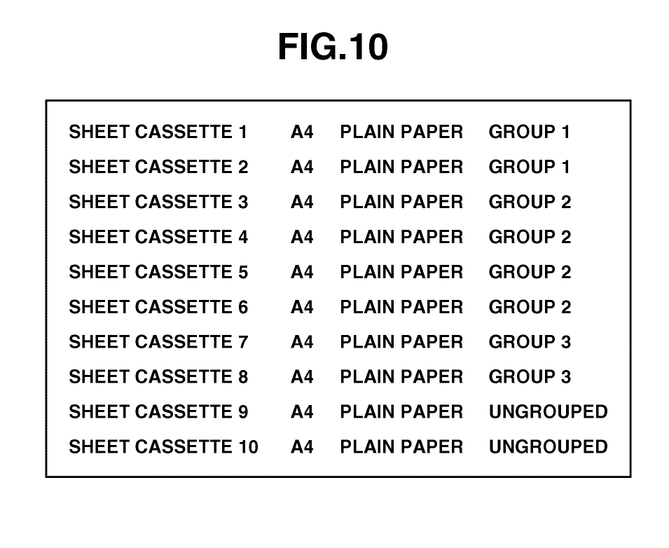

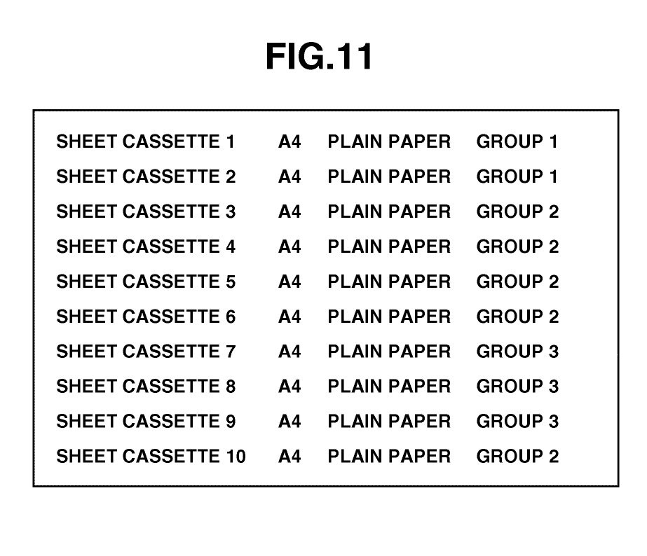

In the present exemplary embodiment, the sheet cassettes are set as illustrated in FIG. 10 or FIG. 11. Accordingly, the above described grouping setting enables grouping of the sheet size, the sheet type, and the group information in association with each of the sheet storage units.

In step S508, the CPU of the control unit 316 adds “1” to the variable C for counting the number of sheet cassettes. Then, the processing returns to step S504 to perform processing from step S504 again.

On the other hand, in a case where the CPU of the control unit 316 determines that C>C_MAX is not satisfied in step S504 (NO in step S504), there remains no sheet cassette to be set, therefore, the CPU ends the sheet cassette information setting.

FIG. 12 is a flow chart illustrating a control method for controlling the printing apparatus according to the present exemplary embodiment. FIG. 12 illustrates an example of page creation processing. Each step is realized by the CPU of the control unit 316 loading the control program read out from the ROM into the RAM to run the control program on the RAM.

In step S602, the data receiving unit 308 receives PDL data created by the printer driver 303 based on the document data of the application within the host computer 101 via the communication I/F 307. In step S603, the interpreter 309 analyzes the PDL data received in step S602.

In step S604, the control unit 316 converts the print data analyzed by the interpreter 309 into intermediate data. The intermediate data is an inclusive term of a drawing object such as a “bit map”, a “run length”, a “trapezoid”, a “box”, and a “high speed boundary encoded bit map”, a background pattern, and a plotting logic when the drawing object and the plotting logic are drawn on a raster memory.

In step S605, the control unit 316 performs a RIP process on the created intermediate data 310 and ends the present processing. Here, the RIP means that the control unit 316 converts the intermediate data 310 into image data by using the renderer 311 to store the image data in the image data storage unit 312. At the time, the control unit 316 substitutes the total number of pages into a variable P_MAX indicating the total number of pages. In the present exemplary embodiment, P_MAX=1000. Namely, the total number of pages is 1000.

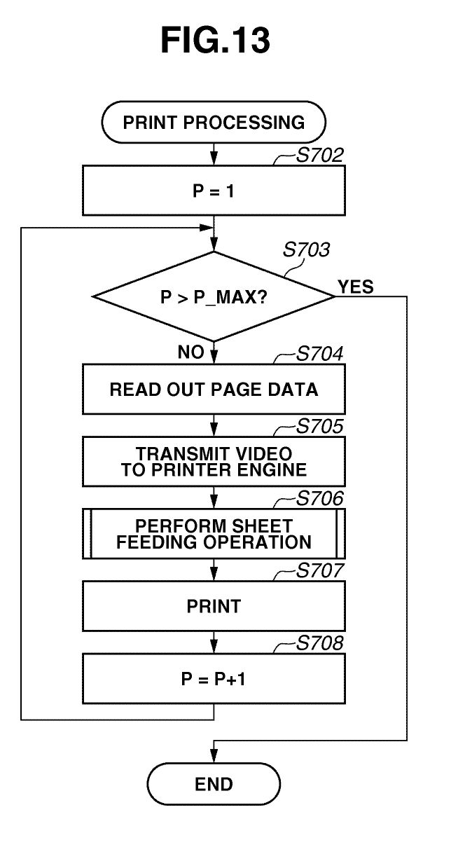

FIG. 13 is a flow chart illustrating a control method for controlling the printing apparatus according to the present exemplary embodiment. FIG. 13 illustrates an example of print processing. Each step is realized by the CPU of the control unit 316 loading the control program read out from the ROM into the RAM to run the control program on the RAM.

In step S702, the CPU of the control unit 316 initializes a parameter P indicating the number of pages during the processing to P=1. Here, P is an integer satisfying P≧1.

In step S703, the CPU of the control unit 316 determines whether the parameter P becomes larger than the variable P_MAX indicating the total number of pages. In a case where the CPU of the control unit 316 determines that the parameter P is not larger than the variable P_MAX (NO in step S703), the CPU of the control unit 316 determines that there still are processible pages. Then, the processing proceeds to step S704.

On the other hand, in step S703, in a case where the CPU of the control unit 316 determines that the parameter P is larger than the variable P_MAX (YES in step S703), the CPU of the control unit 316 determines that there is no processible page. Then, the processing is ended.

In step S704, the CPU of the control unit 316 reads out image data of the page P during the processing from the image data storage unit 312.

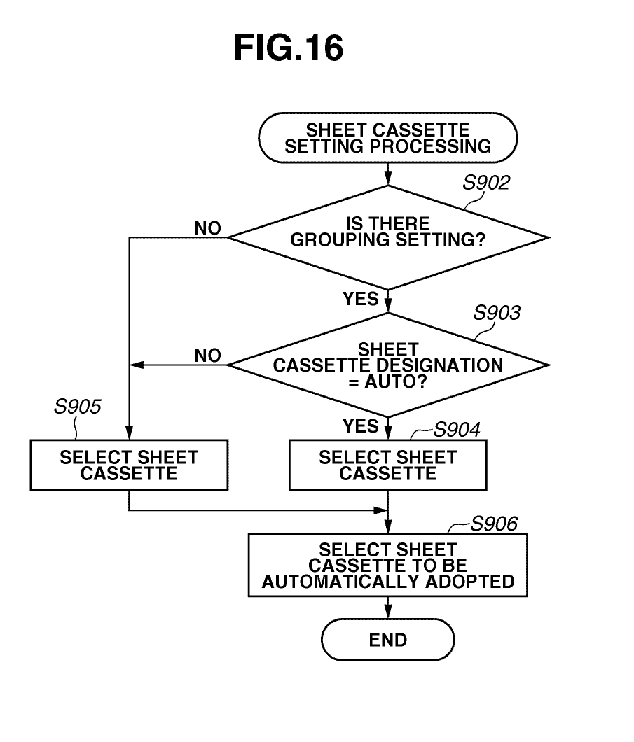

In step S705, the CPU of the control unit 316 converts the image data stored in the image data storage unit 312 into video data to transmit it to the printer engine 313. In step S706, the printer engine 313 performs the sheet feeding operation. Here, the sheets are fed from the preset sheet cassette. The sheet feeding operation is described below in detail with reference to a flow chart of FIG. 16.

In step S707, the CPU of the control unit 316 causes the printer engine 313 to print the video data transmitted in step S705 onto the sheet fed in step S706. In step S708, the CPU of the control unit 316 changes the current page P to the next page P=P+1. Then, the processing returns to step S703 to repeat the processing therefrom.

FIG. 14 is a flow chart illustrating a control method for controlling the printing apparatus according to the present exemplary embodiment. The flow chart may be performed after the page creation processing of step S404 and before the print processing of step S405 of FIG. 4. Each step is realized by that the CPU of the control unit 316 loading the control program read out from the ROM into the RAM to run the control program on the RAM.

In step S802, the CPU of the control unit 316 determines whether the sheet cassettes of the MFP 201 are grouped by referring to setting information managed by the storage unit 315. The sheet cassette grouping setting is performed in step S507. NVRAM region may be secured on the RAM within the control unit 316 instead of the storage unit 315 and the set information may be stored in a nonvolatile RAM.

In a case where the CPU of the MFP 201 determines that the sheet cassettes are grouped (YES in step S802), the processing proceeds to step S803. In a case where the CPU of the control unit 316 determines that the sheet cassettes are not grouped (NO in step S802), the processing proceeds to step S817.

In step S803, the CPU of the control unit 316 determines whether the sheet cassette designation instructed by the printer driver 303 via, for example, a command is automatically performed. In a case where the CPU of the control unit 316 determines that the sheet cassette designation is automatically performed (YES in step S803), the processing proceeds to step S804. To the contrary, in a case where the CPU of the control unit 316 determines that the sheet cassette designation is not automatically performed (NO in step S803), the processing proceeds to step S819.

In step S804, since the sheet cassette designation is automatically performed, the CPU of the control unit 316 determines whether the paper feeding from the grouped sheet cassettes is to be permitted. Whether the paper feeding from the sheet cassettes having been grouped is permitted is preliminarily set by the user via the UI screen 317 and the setting is stored in the storage unit 315. Therefore, the CPU of the control unit 316 can determine whether the user who has set the grouping permits the paper feeding from the group. More specifically, the CPU of the control unit 316 reads out the setting information of the sheet cassette from the storage unit 315 to make the determination.

In a case where the CPU of the control unit 316 determines that the paper feeding from the sheet cassettes having been grouped is permitted (YES in step S804), the processing proceeds to step S805. On the other hand, the CPU of the control unit 316 determines that the sheet feeding from the sheet cassettes having been grouped is not permitted (NO in step S804), the processing proceeds to step S809. In step S805, the control unit 316 counts the number of sheet cassettes belonging to each group.

In step S806, the CPU of the control unit 316 selects a group including the largest number of sheet cassettes based on the result of step S805. When taking FIG. 10 or FIG. 11 as an example, “group 2” is selected in this case.

In step S807, the CPU of the control unit 316 selects one of the sheet cassettes belonging to the group selected in step S806 and the selected sheet cassette is registered in the storage unit 315 as the current sheet cassette. When taking FIG. 10 or FIG. 11 as an example, the current sheet cassette is set to “sheet cassette 3”. In a case where there is a plurality of sheet cassettes belonging to the group selected in step S806, the sheet cassette is selected in the order having higher priority preliminarily set in the printing apparatus.

In step S808, the CPU of the control unit 316 registers the sheet cassettes belonging to the group selected in step S806 in the storage unit 315 as the sheet cassettes to be automatically selected. When taking FIG. 10 as an example, the sheet cassette 3, the sheet cassette 4, the sheet cassette 5, and the sheet cassette 6 are registered as the sheet cassettes to be automatically selected. When taking FIG. 11 as an example, the sheet cassette 3, the sheet cassette 4, the sheet cassette 5, the sheet cassette 6, and the sheet cassette 10 are registered as the sheet cassettes to be automatically selected.

On the other hand, in step S809, the CPU of the control unit 316 determines whether the sheet cassette grouping setting is made to all the sheet cassettes of the MFP 201. The grouping setting is made in step S507. In a case where the CPU of the MFP 201 determines that all the sheet cassettes are grouped (YES in step S809), the processing proceeds to step S812. For example, it is a case where the sheet cassettes are set in a manner as illustrated in FIG. 11. To the contrary, in a case where there is the sheet cassette ungrouped among the sheet cassettes of the MFP 201 (NO in step S809), the processing proceeds to step S810. For example, it is a case where the sheet cassettes are set in a manner as illustrated in FIG. 10.

In step S810, the CPU of the control unit 316 selects the ungrouped sheet cassette to which the cassette grouping setting is not made and registers thus selected sheet cassette in the storage unit 315 as the current sheet cassette. In a case where there is a plurality of sheet cassettes which are not grouped, the CPU of the control unit 316 selects the sheet cassette in the order having higher priority preliminarily set in the printing apparatus as the current sheet cassette. In the present exemplary embodiment, even in a case where a sheet feeding method in which the sheet is fed by using a specific sheet cassette is set in step S809, the CPU of the control unit 316 switches the sheet cassette to the other sheet cassette in step S810. In other words, in a case where the feeding method according to the sheet size is designated by the print job received from the information processing apparatus 101, the CPU of the control unit 316 invalidates the feeding method in which the specific sheet cassette is used and switches to the feeding method in which the sheet cassette capable of accommodating the sheets having a specific size is used.

Accordingly, in a case where the CPU of the control unit 316 receives a print job in which the sheet size is designated, the CPU of the control unit 316 ignores the setting of the grouping having set to the sheet storage unit and allows the sheet feeding from the sheet storage unit accommodating the sheets corresponding to the designated sheet size.

As illustrated in FIG. 10, the sheet cassette 9 or the sheet cassette 10 falls under this case and thus the control unit 316 registers the sheet cassette 9 in the storage unit 315.

In step S811, the CPU of the control unit 316 registers the sheet cassette not belonging to the sheet cassette group in the storage unit 315 as the sheet cassette to be automatically selected. When taking FIG. 10 as an example, the sheet cassette 9 and the sheet cassette 10 fall under the case and thus the control unit 316 registers the sheet cassette 9 and the sheet cassette 10 in the storage unit 315.

On the other hand, in step S812, the CPU of the control unit 316 displays an alarm message on the UI screen 317 to the effect that there is no sheet cassette capable of feeding sheets. The alarm message is displayed in a case where all the sheet cassettes belong to either one of groups and the sheet feeding from the grouped sheet cassettes is not permitted.

In step S813, the CPU of the control unit 316 releases the sheet cassette grouping setting. Accordingly, the grouping of all the sheet cassettes of the MFP 102 is released.

In step S814, when the user selects, via the UI screen 317, the sheet cassette from which the user desires the paper feeding, the CPU of the control unit 316 registers thus selected sheet cassette in the storage unit 315 as the current sheet cassette. When taking FIG. 10 as an example, the control unit 316 registers the sheet cassette 2 in the storage unit 315.

In step S815, the CPU of the control unit 316 sets all the sheet cassettes as the sheet cassettes to be automatically selected and thus registers all the sheet cassettes in the storage unit 315.

In step S816, the CPU of the control unit 316 reads out the sheet cassette to be automatically selected from the storage unit 315 to display it on the UI screen 317. Then, the processing is ended. The processing in step S816 is performed for notifying the user, who does not know that the sheet cassettes are grouped, which sheet cassette can be automatically selected.

In a case where the processing proceeds to step S817, since grouping of the sheet cassettes is not made, the CPU of the control unit 316 selects the sheet cassette from which the sheets are to be fed according to a sheet cassette command from the printer driver 303 and registers the selected sheet cassette as the current sheet cassette in the storage unit 315. In step S818, the CPU of the control unit 316 registers all the sheet cassettes in the storage unit 315 as the sheet cassettes to be automatically selected. Then, the processing is ended.

In a case where the processing proceeds to step S819, the CPU of the control unit 316 selects the sheet cassette from which the sheet is to be fed based on the sheet cassette command from the printer driver 303 and the selected sheet cassette is registered in the storage unit 315 as the current sheet cassette.

In step S820, since there is no sheet cassette to be automatically selected, the CPU of the control unit 316 registers only the current sheet cassette in the storage unit 315 as the sheet cassette to be automatically selected. Then, the processing is ended.

FIG. 15 is a flow chart illustrating a control method for controlling the printing apparatus according to the present exemplary embodiment. FIG. 15 illustrates an example of sheet feeding processing. Each step is realized by the CPU of the control unit 316 loading the control program read out from the ROM into the RAM to run the control program on the RAM.

In step S1002, the CPU of the control unit 316 reads out information of the current sheet cassette set in FIG. 14 from the storage unit 315 and makes a paper feeding request to the sheet cassette.

In step S1003, the CPU of the control unit 316 determines whether the sheet cassette set in step S1002 accommodates sheets having the sheet size and/or sheet type suitable for printing and the sheets are actually accommodated in the sheet cassette based on the setting information of the sheet cassette illustrated in FIG. 10 or FIG. 11 and output information of a sensor mounted on the sheet cassette. In a case where the CPU of the control unit 316 determines that the sheets suitable for printing are not accommodated in the sheet cassette or the sensor is detecting absence of the sheets (YES in step S1003), the processing proceeds to step S1004. On the other hand, in step S1003, the CPU of the control unit 316 determines that the sheets suitable for printing are accommodated in the sheet cassette and the sensor is detecting the presence of the sheets (NO in step S1003), the processing proceeds to step S1008.

In step S1004, the CPU of the control unit 316 determines whether there is the sheet cassette to be automatically selected as set in FIG. 14. In a case where the CPU of the control unit 316 determines that there is a switchable sheet cassette in the sheet cassettes to be automatically selected (YES in step S1004), the processing proceeds to step S1005. On the other hand, in a case where the CPU of the control unit 316 determines that there is no switchable sheet cassette (NO in step S1004), the processing proceeds to step S1006.

In step S1005, the CPU of the control unit 316 selects one of the sheet cassettes among the sheet cassettes to be automatically selected. Normally, the CPU of the control unit 316 selects the sheet cassette in the order having higher priority preliminarily set in the printing apparatus.

In step S1006, since there is no sheet remaining in the current sheet cassette, the CPU of the control unit 316 displays an alarm indicating the absence of sheets on the UI screen 317. In step S1007, the CPU of the control unit 316 waits for a user or an operator to supply sheets to the sheet cassette. In a case where the sensor of the paper sheet feeding unit detects that the sheets are supplied to the sheet cassette, the processing proceeds to step S1008. In step S1008, the printer engine 313 feeds the sheets from the sheet cassette. Then, the processing is ended.

In the first exemplary embodiment, a case is described where the sheets are fed from the sheet cassette belonging to the group or a case where the sheets are fed from the sheet cassette not belonging to the group, when the sheet cassette designation is automatically made. However, in a case where the sheet cassette designation is automatically made, the control unit 316 may perform control so as to ignore the grouping setting. Processing in which the flow of FIG. 14 is replaced with the flow of FIG. 16, is described below with respect to a second exemplary embodiment. In other words, the processing illustrated in FIG. 16 may be performed after the page creation processing of step S404 and before the print processing of step S405.

FIG. 16 is a flow chart illustrating a control method for controlling the printing apparatus according to the present exemplary embodiment. FIG. 16 illustrates an example of the sheet cassette setting. Each step is realized such that the CPU of the control unit 316 loads the control program read out from the ROM into the RAM to run the control program on the RAM.

In step S902, the CPU of the control unit 316 determines whether the sheet cassette grouping setting is made with respect to the sheet cassettes of the MFP 102. The sheet cassette grouping setting is performed in step S507 of FIG. 5. In a case where the CPU of the control unit 316 determines that the sheet cassettes of the MFP 102 are grouped (YES in step S902), the processing proceeds to step S903.

On the other hand, in step S902, in a case where the CPU of the control unit 316 determines that the sheet cassettes of the MFP 102 are not grouped (NO in step S902), the processing proceeds to step S905.

In step S903, the CPU of the control unit 316 determines whether the sheet cassette designation instructed by the printer driver 303 via, for example, a command is automatically made. In a case where the CPU of the control unit 316 determines that the sheet cassette designation is automatically made (YES in step S903), the processing proceeds to step S904. On the other hand, in a case where the CPU of the control unit 316 determines that the sheet cassette designation is not automatically made (NO in step S903), the processing proceeds to step S905.

In step S904, the CPU of the control unit 316 ignores the grouping setting and selects the sheet cassette. In a case of the present exemplary embodiment, the CPU of the control unit 316 sets the sheet cassettes in the order having the higher priority preliminarily set in the MFP 201. The CPU of the control unit 316 registers the sheet cassette in the storage unit 315 as the current sheet cassette. In the present exemplary embodiment, the sheet cassette 1 is set.

In step S905, the CPU of the control unit 316 registers the sheet cassette in the storage unit 315 as the current sheet cassette according to the sheet cassette designation designated by the printer driver 303 via, for example, a command.

In step S906, the CPU of the control unit 316 registers all the sheet cassettes in the storage unit 315 as the sheet cassettes to be automatically selected. Then, the processing is ended.

In the above described exemplary embodiment, the sheet cassette number, sheet size, sheet type, and group number are constant, but the present invention is not limited thereto (third exemplary embodiment). This is applied also to the below described fourth exemplary embodiment.

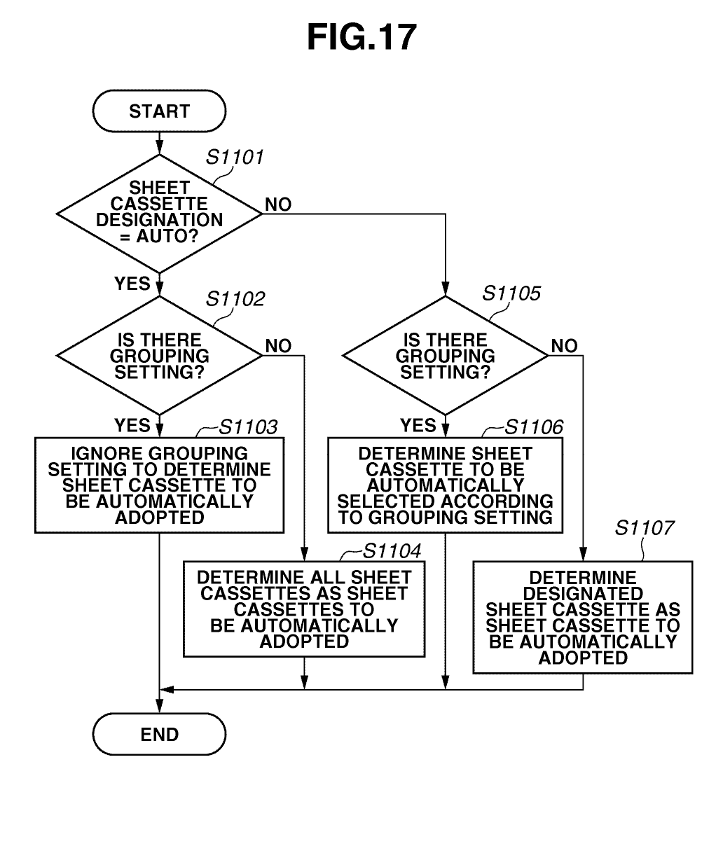

A fourth exemplary embodiment is a modification of the second exemplary embodiment. In the second exemplary embodiment, a case where the sheets are fed from the sheet cassette belonging to the group or a case where the sheets are fed from the sheet cassette not belonging to the group is described, when the sheet cassette designation is automatically made. However, in a case where the sheet cassette designation is automatically made, the control unit 316 may perform control so as to ignore the grouping setting itself. Processing in which the flow of FIG. 14 is replaced with a flow of FIG. 17 is described below according to the present exemplary embodiment. In other words, the processing illustrated in FIG. 17 may be performed after the page creation processing of step S404 and before the print processing of step S405.

FIG. 17 is a flow chart illustrating a control method for controlling the printing apparatus according to the present exemplary embodiment. FIG. 17 illustrates an example of sheet cassette setting. Each step is realized such that the CPU of the control unit 316 loads the control program read out from the ROM into the RAM to run the control program on the RAM.

In step S1101, the CPU of the control unit 316 determines whether the sheet cassette designation instructed by the printer driver 303 via, for example, a command is automatically made. In a case where the CPU of the control unit 316 determines that the sheet cassette designation is automatically made (YES in step S1101), the processing proceeds to step S1102. In a case where the CPU of the control unit 316 determines that the sheet cassette designation is not made automatically (NO in step S1101), the processing proceeds to step S1105.

In step S1102, the CPU of the control unit 316 determines whether the sheet cassettes of the MFP 102 are grouped. The sheet cassette grouping setting is performed in step S507 of FIG. 5. In a case where the CPU of the control unit 316 determines that the sheet cassettes of the MFP 102 are grouped (YES in step S1102), the processing proceeds to step S1103. On the other hand, in step S1102, in a case where the CPU of the control unit 316 determines that the sheet cassettes of the MFP 102 are not grouped (NO in step S1102), the processing proceeds to step S1104.

In step S1103, the CPU of the control unit 316 ignores the sheet cassette grouping setting performed in step S507 of FIG. 5 to determine the sheet cassette to be automatically selected. In other words, the CPU of the control unit 316 selects the sheet cassette of which sheet size and/or sheet type matches the one designated in the received PDL data (i.e., designated by the command from the printer driver 303) from among all the sheet cassettes capable of feeding sheets by the MFP 102 as the sheet cassette to be automatically selected. Then, the processing of FIG. 17 is ended and the processing proceeds to step S405 of FIG. 4.

In a case where the processing proceeds to step S1104, the CPU of the control unit 316 selects the sheet cassette of which sheet size and/or sheet type matches the designated one in the received PDL data (i.e., designated by the command from the printer driver 303) from among all the sheet cassettes of sheets which the MFP 102 can feed as the sheet cassette, to be automatically selected. Then, the processing of FIG. 17 is ended and the processing proceeds to step S405 of FIG. 4.

In a case where the processing proceeds to step S1105 from step S1101, the CPU of the control unit 316 determines whether the sheet cassettes of the MFP 102 are grouped. The sheet cassette grouping setting is performed in step S507 of FIG. 5. In a case where the CPU of the control unit 316 determines that the sheet cassettes of the MFP 102 are grouped (YES in step S1105), the processing proceeds to step S1106. On the other hand, in step S1105, in a case where the CPU of the control unit 316 determines that the sheet cassettes of the MFP 102 are not grouped (NO in step S1105), the processing proceeds to step S1107.

In step S1106, the CPU of the control unit 316 selects the sheet cassette of which sheet size and/or sheet type matches the designated one in the received PDL data (i.e., designated by the command from the printer driver 303) from among all the sheet cassettes of sheets which the MFP 102 can feed as the sheet cassette, to be automatically selected. Then, the processing of FIG. 17 is ended and the processing proceeds to step S405 of FIG. 4.

In step S1106, the CPU of the control unit 316 determines the sheet cassette to be automatically selected according to the grouping setting. In other words, the CPU of the control unit 316 determines the sheet cassette of which sheet size and/or sheet type matches the sheet cassette in the group to which the sheet cassette designated in the received PDL data (i.e., designated by the command from the printer driver 303) belongs, to be automatically selected. Then, the processing of FIG. 17 is ended and the processing proceeds to step S405 of FIG. 4.

In step S1107, the CPU of the control unit 316 determines only the designated sheet cassette as the sheet cassette to be automatically selected. Then, the processing of FIG. 17 is ended and the processing proceeds to step S405 of FIG. 4. In a case where the processing of step S1107 is performed, the printing is performed without switching the sheet feeding source to the other sheet cassette even in a case where the sheets accommodated in the designated sheet cassette run out.

As described above, print processing is performed in step S405 of FIG. 4 by using the sheet cassette determined as the sheet cassette to be automatically selected. The printing is continued by switching the sheet feeding source to the other sheet cassette if there is the other sheet cassette determined as the sheet cassette to be automatically selected even in a case where the sheet feeding source runs out of sheets.

Accordingly, in a case where the user desires to apply grouping setting, the user designates a specific sheet cassette to instruct a transmission of the print data, so that the control unit 316 can select the sheet cassette to be used in printing according to the grouping setting. For example, the grouping is set in a manner as illustrated in FIG. 10, and the sheet cassettes 4 through 6 can be selected as the sheet cassettes to be used in printing by transmitting the print data in which the sheet cassette 5 is designated. On the other hand, in a case where the user does not desire to apply the grouping setting, the user designates the sheet size and/or the sheet type and sets the selection of the sheet cassette to “auto”. Accordingly, more sheet cassettes can be selected as the sheet cassettes to be used in printing, by instructing the transmission of the print data, regardless of the grouping setting.

For example, the grouping is set in a manner as illustrated in FIG. 10 and the selection of the sheet cassette is set to “auto” to transmit the print data. Accordingly, the sheet cassettes 1 through 10 can be selected as the sheet cassettes to be used in printing. In the above described exemplary embodiment, the sheet cassettes 1 through 10 are all set to accommodate A4 size-plain paper sheets, so that all the sheet cassettes 1 through 10 are selected as the sheet cassettes to be used in printing. However, in cases where the sheets having different size or different type are set and where the sheet size and the sheet type do not match the sheet size and the sheet type of the sheets designated by the print data, the sheet cassettes storing the unmatched sheets are delisted from the sheet cassettes to be automatically selected.

### Other Embodiments

In the above described exemplary embodiment of a print job, the print data is transmitted from the PC 101 to the MFP 201 and the MFP 201 prints an image on a sheet according to the print data. However, the present invention is not limited to the above but can be applied to a copy job in which the scanner 314 reads out a document to print thus read out document image on a sheet. Further, the present invention can be applied to a box print job in which the image stored in the storing unit 315 is read out and thus read out image is printed on a sheet. In a case where the present invention is applied to the copy job or the box print job, the print setting described in step S405 of FIG. 4 is received via the UI screen 317 of the MFP 201.

In the above described exemplary embodiment, in a case where the CPU of the control unit 316 determines that the sheet cassette is automatically designated in step S803, the CPU of the control unit 316 advances the processing to step S804. However, the present invention is not limited thereto but the CPU of the control unit 316 may advance the processing to step S805 without performing the processing of step S804 in a case where the CPU of the control unit 316 determines that the sheet cassette is automatically designated in step S803.

In the above described exemplary embodiment, the sheet cassette is switched upon detecting running out of sheets in step S1003. However, the sheet cassette may be switched according to a detection result that an amount of sheets of the sheet cassette as the sheet feeding source becomes equal to or less than, but not 0, a predetermined amount.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-190495 filed Sep. 1, 2011, which is hereby incorporated by reference herein in its entirety.

What is claimed is:

1. A printing system for conveying a sheet from any one of a plurality of sheet storage units and printing an image on the conveyed sheet, the printing system comprising:
a registering unit configured to register 2 or more sheet storage units as a group among the plurality of sheet storage units; and
a control unit configured to continue printing by changing a sheet conveyance source based on the group registered by the registering unit in a case where an amount of sheets accommodated in a specific sheet storage unit becomes equal to or less than a predetermined amount during execution of a job in which the specific sheet storage unit is designated among the plurality of sheet storage units, and to continue printing by changing the sheet storage unit to the other sheet storage unit accommodating sheets having the designated size, regardless of the group registered in the registering unit, in a case where an amount of sheets of the sheet storage unit accommodating the sheets having the designated size becomes equal to or less than a predetermined amount during execution of the job in which a size of the sheet is designated.

2. A printing system according to claim 1, wherein the control unit continues printing by changing the sheet storage unit to the other sheet storage unit, in which sheets of the designated size are accommodated, among all the sheet storage units which can be used as a sheet conveyance source in a case where a sheet amount of the sheet storage unit accommodating sheets having the designated size becomes equal to or less than a predetermined amount during execution of a job in which the sheet size is designated.

3. A printing system according to claim 1, wherein the control unit continues printing by changing the sheet storage unit to the other sheet storage unit, in which sheets of the designated size are accommodated, among the sheet storage units which are not registered as the group by the registering unit in a case where a sheet amount of the sheet storage unit accommodating sheets having the designated size becomes equal to or less than a predetermined amount during execution of a job in which the sheet size is designated.

4. A printing system according to claim 1, wherein the control unit continues printing, in a case where an amount of sheets accommodated in a specific sheet storage unit becomes equal to or less than a predetermined amount during execution of a job in which the specific sheet storage unit is designated among the plurality of sheet storage units, by changing a sheet conveyance source to the other sheet storage unit belonging to a group of the specific sheet storage unit.

5. A printing system according to claim 1, further comprising:
a reading unit configured to read an image of a document;
wherein the printing system conveys a sheet from any one of the plurality of sheet storage units and prints the image of the document read by the reading unit on thus conveyed sheet.

6. A printing system according to claim 1, further comprising:
a receiving unit configured to receive image data from an external device;
wherein the printing system conveys a sheet from any one of the plurality of sheet storage units and prints the image on thus conveyed sheet according to the image data received by the receiving unit.

7. A control method for controlling a printing system for conveying a sheet from any one of a plurality of sheet storage units and printing an image on thus conveyed sheet, the control method comprising:
registering 2 or more sheet storage units as a group among the plurality of sheet storage units; and
continuing printing by changing a sheet conveyance source based on the registered group in a case where a sheet amount accommodated in a specific sheet storage unit becomes equal to or less than a predetermined amount during execution of a job in which the specific sheet storage unit is designated among the plurality of sheet storage units, and continuing printing by changing the sheet storage unit to the other sheet storage unit accommodating sheets having a designated size, regardless of the registered group, in a case where a sheet amount of the sheet storage unit accommodating sheets having the designated size becomes equal to or less than a predetermined amount during execution of the job in which a sheet size is designated.

8. A non-transitory computer readable storage medium for storing a computer program for controlling a printing system for conveying a sheet from any one of a plurality of sheet storage units to print an image on thus conveyed sheet, the computer program comprising:
a code to register 2 or more sheet storage units as a group among the plurality of sheet storage units; and
a code to continue printing by changing a sheet conveyance source based on the registered group in a case where a sheet amount accommodated in the specific sheet storage unit becomes equal to or less than a predetermined amount during execution of a job in which a specific sheet storage unit is designated among the plurality of sheet storage units, and to continue printing by changing the sheet storage unit to the other sheet storage unit accommodating sheets having the designated size, regardless of the registered group, in a case where a sheet amount of the sheet storage unit accommodating sheets of the designated size becomes equal to or less than a predetermined amount during execution of the job in which a sheet size is designated.
